(19) United States
(12) Patent Application Publication
(10) Pub. No.: US 2018/0124220 A1
(43) Pub. Date: May 3, 2018

(54) DEPLOYING AN INTERNET STORAGE NAME SERVICE (iSNS) SERVER ON A NETWORK DEVICE

(71) Applicant: Hewlett Packard Enterprise Development LP, Houston, TX (US)

(72) Inventors: Krishna Puttagunta, Roseville, CA (US); Rupin T. Mohan, Littleton, MA (US); Vivek Agarwal, Littleton, MA (US)

(21) Appl. No.: 15/337,953

(22) Filed: Oct. 28, 2016

(51) Int. Cl. H04L 29/14; H04L 29/08; H04L 12/26

(52) U.S. Cl. CPC H04L 69/40; H04L 43/10; H04L 67/1097

(57) ABSTRACT

Examples disclosed herein relate to deployment of an Internet Storage Name Service (iSNS) server on a network device. In an example, a network device may determine that the network device has a highest IP address among network devices in an Internet Small Computer System Interface (iSCSI) network. In response to the determination, network device may deploy a primary Internet Storage Name Service (iSNS) server, and provide an in-band network access between the primary iSNS server and an iSCSI device on the iSCSI network.

### BACKGROUND

Internet Small Computer Systems Interface (iSCSI) is an Internet Protocol (IP)-based storage networking standard for linking data storage facilities. iSCSI may provide block-level access to storage devices over a TCP/IP network. iSCSI may be used for location-independent data storage and retrieval over local area networks (LANs), wide area networks (WANs), or the Internet.

### BRIEF DESCRIPTION OF THE DRAWINGS

For a better understanding of the solution, embodiments will now be described, purely by way of example, with reference to the accompanying drawings, in which:

FIG. 1 is a block diagram of an example computing environment for deploying an Internet Storage Name Service (iSNS) server on a network device;

FIG. 2 is a block diagram of an example network device to deploy an Internet Storage Name Service (iSNS) server;

FIG. 3 is a block diagram of an example method for deploying an Internet Storage Name Service (iSNS) server on a network device; and

FIG. 4 is a block diagram of an example system including instructions in a machine-readable storage medium to deploy an Internet Storage Name Service (iSNS) server on a network device.

### DETAILED DESCRIPTION

iSCSI is a storage area network (SAN) protocol that may allow organizations to consolidate storage into storage arrays while providing hosts (such as web servers) with the illusion of locally attached disks. The iSCSI protocol may allow clients (called initiators) to send SCSI commands to SCSI storage devices (targets) on remote servers.

The iSCSI protocol has faced concerns about its performance, reliability and management. As compared to Fiber Channel deployments, iSCSI tables may lack certain features like fabric hosted name service, zoning and ease of configuration. To overcome these drawbacks, iSNS (Internet Storage Name Service) was defined to provide a centralized name service for all iSCSI nodes of one or more fabrics.

The Internet Storage Name Service (iSNS) protocol may allow automated discovery, management and configuration of iSCSI devices on a TCP/IP network. However, iSNS implementations may involve a separate standalone out-of-band server or workstation to host an iSNS server, and may also entail a significant amount of manual configurations before end devices are able to establish connectivity and start transacting I/O operations. Additionally, there is no well-defined mechanism for handling iSNS server failures, which may become a single point of failure in the network, which may not be a desirable scenario.

To address these issues, examples described herein may deploy an Internet Storage Name Service (iSNS) server on a network device. In an example, a network device may determine that it has a highest IP address among network devices in an Internet Small Computer System Interface (iSCSI) network. In response to the determination, the network device may deploy an Internet Storage Name Service (iSNS) server. Further to the deployment, the network device may provide an in-band network access between the primary iSNS server and an iSCSI device on the iSCSI network. Such examples may allow iSCI initiators and iSCI target devices to register with an iSNS server via an “in-band” mechanism. As used herein, “in-band” network access may refer to a network usage wherein the same network may be used to monitor and control a data network and to communicate data packets not used for management or control of that data network. In an example, during in-band network access, network management information (for example, via Simple Network Management Protocol (SNMP) packets) may travel the same network path as normal data packets (i.e., data packets whose content does not relate to management or control of that network).

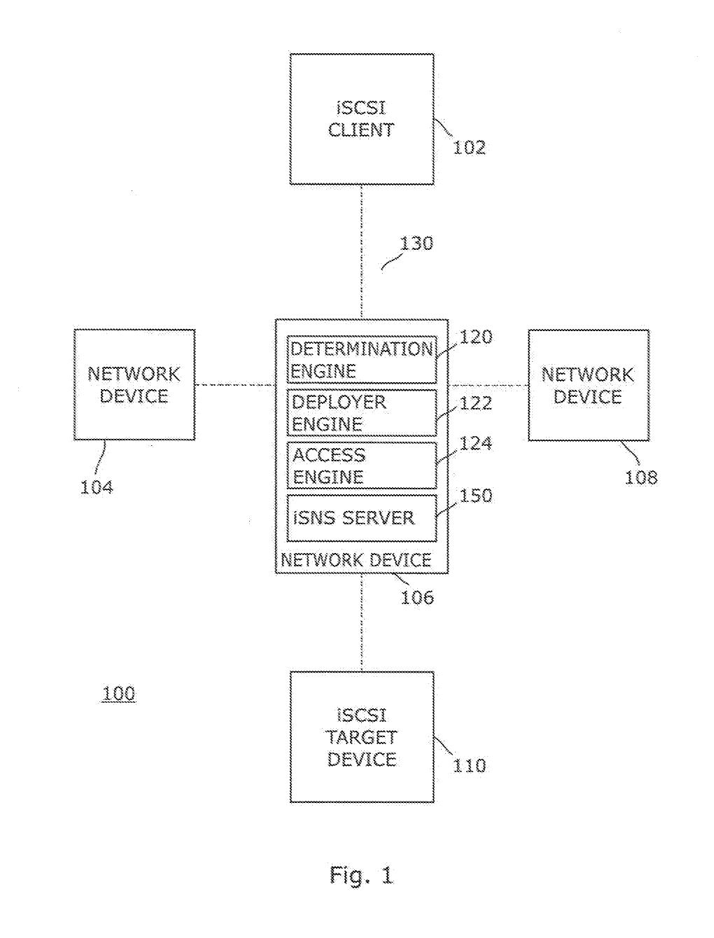

FIG. 1 is a block diagram of an example computing environment 100 for deploying an Internet Storage Name Service (iSNS) server on a network device. Computing environment 100 may include an iSCSI client 102, network devices 104, 106, and 108, and an iSCSI target device 110. Although only one iSCSI client, one iSCSI target device, and three network devices are shown in FIG. 1, other examples of this disclosure may include more than one iSCSI client, more than one iSCSI target device, and mere or less than three network devices.

iSCSI client 102 may be any type of computing device capable of executing machine-readable instructions. Examples of iSCSI client 102 may include, without limitation, a server, a desktop computer, a notebook computer, a tablet computer, a thin client, a mobile device, a personal digital assistant (PDA), a phablet, and the like. In an example, iSCSI client 102 may be referred to as iSCSI initiator.

iSCSI target device 110 may be a computing device, a storage device or a combination thereof. For example, iSCSI target device 110 may include, without limitation, a server, a desktop computer, a notebook computer, a tablet computer, a thin client, a mobile device, a personal digital assistant (PDA), and the like. In another example, iSCSI target device 110 may be an internal storage device, an external storage device, or a network attached storage device. Other examples of iSCSI target device 110 may include a hard disk drive, a storage disc (for example, a CD-ROM, a DVD, etc.), a storage tape, a solid state drive, a USB drive, a Serial Advanced Technology Attachment (SATA) disk drive, a Fibre Channel (FC) disk drive, a Serial Attached SCSI (SAS) disk drive, a magnetic tape drive, an optical jukebox, and the like. In other examples, iSCSI target device 110 may be a Direct Attached Storage (DAS) device, a Network Attached Storage (NAS) device, a Redundant Array of Inexpensive Disks (RAID), a data archival storage system, or a block-based device over a storage area network (SAN). In one example, iSCSI target device 110 may be a storage array, which may include one or more storage drives (for example, hard disk drives, solid state drives, etc.).

In an example, the physical storage space provided by iSCSI target device 110 may be presented as a logical storage space. Such logical storage space (also referred as “logical volume”, “virtual disk”, or “storage volume”) may be identified using a “Logical Unit Number” (LUN). In another instance, physical storage space provided by iSCSI target device 110 may be presented as multiple logical volumes (“iSCSI targets”). In such case, each of the logical storage spaces (“iSCSI targets”) may be referred to by a separate LUN. For example, if iSCSI target device 110 is a physical disk, a LUN may refer to the entire physical disk, or a subset of the physical disk or disk volume. In another example, if iSCSI target device 110 is a storage array comprising multiple storage disk drives, physical storage space provided by the disk drives may be aggregated as a logical storage space. The aggregated logical storage space may be divided into multiple logical storage volumes, wherein each logical storage volume may be referred to by a separate LUN. LUNs, thus, may be used to identify individual or collections of physical disk devices for address by a protocol associated with a Small Computer System Interface (SCSI), Internet Small Computer System Interface (iSCSI), or Fibre Channel (FC). Thus, in an example, iSCSI target device 110 may include one or more iSCSI targets.

As used herein, a “network device” may refer to any type of networking device that may be capable of routing packets. In examples, a network device may include a network switching device, such as a network switch, a network router, a virtual switch, or a virtual router.

Network devices 104, 106, and 108 may each include, by way of non-limiting examples, a network switch, a network router, a virtual switch, and a virtual router.

iSCSI client 102, network devices 104, 106, and 108, and an iSCSI target 110 may be in communication, for example, via a network 130. The network 130 may be a wireless or wired network. Network 130 may include, for example, a Local Area Network (LAN), a Wide Area Network (WAN), a Metropolitan Area Network (MAN), a Storage Area Network (SAN), a Campus Area Network (CAN), or the like. Further, network may 130 be a public network (for example, the Internet) or a private network (for example, an intranet). In an example, network 130 may be an iSCSI network.

iSCSI client 102 may communicate with iSCSI target device 110 via a suitable interface or protocol such as, but not limited to, Internet Small Computer System Interface (iSCSI), Fibre Channel, Fibre Connection (FICON), HyperSCSI, and ATA over Ethernet. In an instance, iSCSI client 102 may send SCSI commands over network to iSCSI target device 110.

In an example at least one of the network devices may include a determination engine 120, a deployer engine 122, and an access engine 124. For the sake of simplicity in illustration, network device 106 is shown to include a determination engine 120, a deployer engine 122, and an access engine 124. However, any or all of the other network devices may include these engines as well.

Engines 120, 122, and 124 may be any combination of hardware and programming to implement the functionalities of the engines described herein. In examples described herein, such combinations of hardware and programming may be implemented in a number of different ways. For example, the programming for the engines may be processor executable instructions stored on at least one non-transitory machine-readable storage medium and the hardware for the engines may include at least one processing resource to execute those instructions. In some examples, the hardware may also include other electronic circuitry to at least partially implement at least one engine of network device 106. In some examples, the at least one machine-readable storage medium may store instructions that, when executed by the at least one processing resource, at least partially implement some or all engines of the device 106. In such examples, device 106 may include the at least one machine-readable storage medium storing the instructions and the at least one processing resource to execute the instructions.

Determination engine 120 may determine whether an Internet Storage Name Service (iSNS) server may be deployed on network device 106. As used herein, a “server” may refer to a computer program (machine-readable instructions) or process that may process requests from other (client) computers received over a network. In an example, iSNS server may include a computer program (machine-readable instructions) or process that may process requests, for example, from an iSCSI device.

In an example, the determination may include determining whether network device 106 has the highest IP address among network devices (for example, 104, 106, and 108) in network 130. In an example, each network device in network 130 may broadcast heartbeat messages that may be received by other network devices in the network. As used herein, a “heartbeat message” may refer to a message sent from an originator network device to a destination network device that may enable the destination network device to identify if and when the originator network device may have failed or may no longer be available. In an example, heartbeat messages may be sent continually on a periodic or recurring basis from the originator network device.

The respective heartbeat messages broadcasted by the network devices may include respective IP addresses of those devices. Determination engine 120 on network device 106 may monitor the respective heartbeat messages received from other network devices in network 130 and compare the IP address of network device 106 with respective IP addresses of other network devices. In response to the comparison, determination engine 120 may determine that network device 106 has the highest IP address amongst network devices in network 130.

In another example, the determination whether an Internet Storage Name Service (iSNS) server may be deployed on network device 106 may include determining whether network device 106 has the highest value of a counter among network devices (for example, 104, 106, and 108) in network 130. In an example, the respective heartbeat messages broadcasted by the network devices may include respective values of a counter in those devices. In an example, each network device may maintain a counter. In an example, a counter value may represent the number of heartbeat messages sent by a network device. The current counter value on a network device may be included in a heartbeat message broadcasted by the network device. Each time a network device sends a heartbeat message the counter value on the network device may be incremented. Determination engine 120 on network device 106 may monitor the respective heartbeat messages received from other network devices in network 130 and may compare its counter value with respective counter values of other network devices provided in the received heartbeat messages. In response to the comparison, determination engine 120 may determine whether network device 106 has the highest counter value amongst network devices in network 130. In the event of a scenario that there's a tie between the counter values on network device 106 and another network device, determination engine 120 may compare IP addresses of these device.

Returning to examples in which the IP address values may be used to determine whether to deploy an iSNS server, in response to the determination that network device 106 has the highest IP address amongst network devices in network 130, deployer engine 122 may deploy an Internet Storage Name Service (iSNS) server 150 on network device 106. In another example, in response to the determination that network device 106 has the highest value of a counter amongst network devices in network 130, deployer engine 122 may deploy an iSNS server 150 on network device 106. In the event of a scenario that there's a tie between the counter values on network device 106 and another network device, determination engine 120 may compare IP addresses of these device. In response to the determination that network device 106 has a higher IP address compared to the other network device, deployer engine 122 may deploy an iSNS server 150 on network device 106.

In an example, deployer engine 122 may be a daemon process that may be used to deploy iSNS server 150 on network device 106. As mentioned earlier, the iSNS protocol may facilitate configuration and management of iSCSI storage devices in an IP network. The iSNS protocol may relieve a user from manual and individual configuration of multiple storage devices each with its own list of known initiators and targets. By using the iSNS protocol, each storage device may subordinate its discovery and management responsibilities to the iSNS server 150. The iSNS server 150 thereby may serve as the consolidated configuration point through which management stations may configure and manage an entire storage network, including iSCSI devices (for example, 102 and 110). The iSNS server 150 may respond to iSNS protocol queries and requests, and initiate iSNS protocol State Change Notifications. For example, iSNS server 150 may be used to establish an iSCSI session between an iSCSI client (for example, 102) and an iSCSI target (for example, 110). An iSCSI client (for example, 102) may obtain information about target devices (for example, 110) from iSNS server 150. iSCI targets (for example, 110) may delegate their access control or authorization policies to iSNS server 150.

In an example, determination engine 120 may identify a second network device among network devices (for example, 104) for deploying a primary backup iSNS server. In such case, the iSNS server on network device 106 may be referred to as “primary active iSNS server”. The primary backup iSNS serve may be deployed on the second network device in the event of failure of network device 106. In the event, the primary backup iSNS server may act as the primary active iSNS server in network 130. In an example, the second network device may include a network device that has the second highest IP address among the network devices. Determination engine 120 may determine the second highest IP address from the IP addresses in the heartbeat messages received from other network devices. In an example, the second network device may include a network device that has the second highest value of a counter among the network devices. Determination engine 120 may determine the second highest value of a counter from the counter values in the heartbeat messages received from other network devices.

In an example, determination engine 120 may identify a third network device among network devices (for example, 108) for deploying a secondary backup iSNS server. The secondary backup iSNS server may be deployed on the third network device in case of failure of the second network device. In the event, the secondary backup iSNS server may act as the primary active iSNS server in network 130. In an example, the third network device may include a network device that has the third highest IP address among the network devices. Determination engine 120 may determine the third highest IP address from the IP addresses in the heartbeat messages received from other network devices. In an example, the third network device may include a network device that has the third highest value of a counter among the network devices. Determination engine 120 may determine the third highest value of a counter from the counter values in the heartbeat messages received from other network devices.

In an example, determination engine 120 may share information related to the primary backup iSNS server and secondary backup iSNS server with other network devices in network 130 via a heartbeat message payload. Some examples of the information may include IP address of the primary backup iSNS server, Transmission Control Protocol (TCP) port of the primary backup iSNS server, User Datagram Protocol (UDP) port of the primary backup iSNS server, IP address of the secondary backup iSNS server, TCP port of the secondary backup iSNS server, and UDP port of the secondary backup iSNS server.

Once the primary active iSNS server is deployed on network device 106, the remaining network devices in network 130 may be placed into a monitoring state. In the monitoring state, the remaining network devices may listen to the heartbeat messages to monitor the health of the primary active iSNS server. The remaining network devices may determine failure of the primary active iSNS server if they do not receive heartbeat messages from network device 106 for a period of time that may be referred to as “Dead Interval” (DI). In an example, the Dead Interval may be three times of the Heartbeat Message Interval (HMI). A used herein, a Heartbeat Message Interval (HMI) may refer to the time interval between two heartbeat messages.

For example, if HMI is 1 second, the DI may be 3 seconds. For example, if the second network device does not receive 3 contiguous iSNS heartbeat messages from network device 106, it may determine that connectivity to the primary active iSNS server has been lost. In such case, the primary backup iSNS server may be deployed on the second network device. Likewise, if the third network device does not receive 3 contiguous iSNS heartbeat messages from the second network device, it may determine that connectivity to the primary backup iSNS server has been lost. In such case, the secondary backup iSNS server may be deployed on the second network device.

In an example, subsequent to the deployment of a primary backup iSNS server or a secondary backup iSNS server, as the case may be, if the determination engine 120 determines that network device 106 is again operational, deployer engine 122 may redeploy the “primary” iSNS server on network device 106. In the event, the primary backup iSNS server or the secondary backup iSNS server, as the case may be, may stop performing the role of primary active iSNS server.

In response to the deployment of iSNS server 150 on network device 106, access engine 124 may provide an in-band network access between the iSNS server and an iSCSI device on network 130. The iSCSI device may include an iSCSI client (for example, 102) or an iSCSI target device (or an iSCSI target) (for example, 110). In an example, the in-band access may allow an iSCSI client or an iSCSI target device to register with the iSNS server on network device 106. In this regard, access engine 124 may receive a registration request from an iSCSI device. In response to the request, access engine may register the iSCSI device with the iSNS server. Access engine 124 may store information related to the iSCSI device in an iSNS database on network device 106. In an example, the iSNS database may be a Lightweight Directory Access Protocol (LDAP) database.

The iSNS database may act as the information repository for the iSNS server. The database may maintain information about iSNS client attributes. For example, properly authenticated information submitted by a registration request may be stored in the iSNS database. In an example, the information in iSNS database may be synchronized with respective iSNS databases on the primary backup iSNS server and the secondary backup iSNS server. In an example, the primary active iSNS server and backup servers may synchronize their LDAP databases using LDAP Content Synchronization protocol. The database synchronization may help a primary backup iSNS server or a secondary backup iSNS server, as the case may be, assume the role of a primary active iSNS server if the latter fails or network device 106 that hosts the primary active iSNS server fails since the iSNS databases on their respective network devices may include synchronized iSNS data and records.

iSNS 150 server may provide a registration function to allow all entities in network 130 to register and query the iSNS database. Both targets and initiators may register in the iSNS database, and query for information about other initiators and targets. This may allow, for example, a client initiator to obtain information about target devices from the iSNS server.

In an example, an iSNS target device (for example, 110) may create discovery domains. Discovery domains (DD) may be defined as a security and management mechanism that may be used to administer access and connectivity to storage devices. The discovery domain service in the iSNS protocol may facilitate the partitioning of storage nodes into more manageable groupings for administrative and login control purposes. It may allow an administrator to limit the login process of each host to a more appropriate subset of targets registered in iSNS server 150. This helps in reducing the number of unnecessary logins (iSCSI logins), and the amount of time that the host spends initializing login relationships as network 130 scales up. Discovery Domains in an iSCSI fabric, like zones in a Fibre Channel fabric, enable you to partition the storage resources in your storage area network (SAN). By creating and managing Discovery Domains, you can control the iSCSI targets that each iSCSI initiator can see and log on to. A Discovery Domain may be created by grouping the initiators and targets that are reported by each Internet Storage Name Service (iSNS) server. In order for an iSCSI target (for example, 110) to be discovered by an iSCSI initiator (for example, 102), both may be members of the same Discovery Domain.

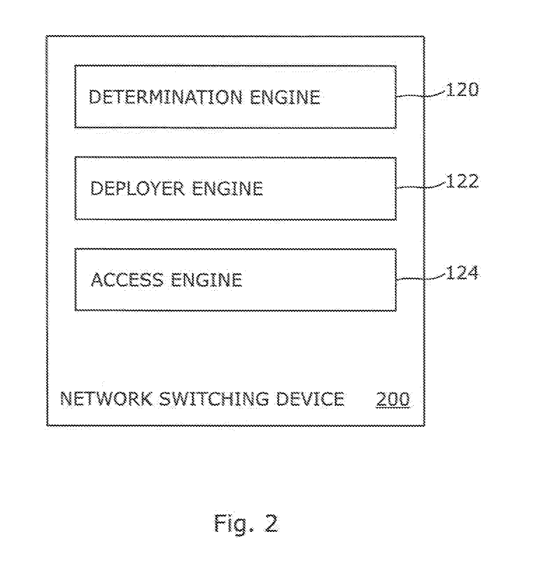

FIG. 2 is a block diagram of an example network device 200 for deploying an Internet Storage Name Service (iSNS) server. In an example, network device 200 may be implemented by any suitable device, as described herein in relation to network device 106 of FIG. 1, for example.

Network device 200 may include a determination engine 120, a deployer engine 122, and an access engine 124, as described above in relation to FIG. 1.

Network device 200 may include, for example, a network switch, a network router, a virtual switch, and a virtual router.

In an example, determination engine 120 may determine that network device 200 has a highest value of a counter among network devices in an Internet Small Computer System Interface (iSCSI) network. In response to the determination, deployer engine 122 may deploy a primary Internet Storage Name Service (iSNS) server on the network device 200. Consequent to the deployment, access engine 124 may provide an in-band network access between the primary active iSNS server and an iSCSI device on the iSCSI network.

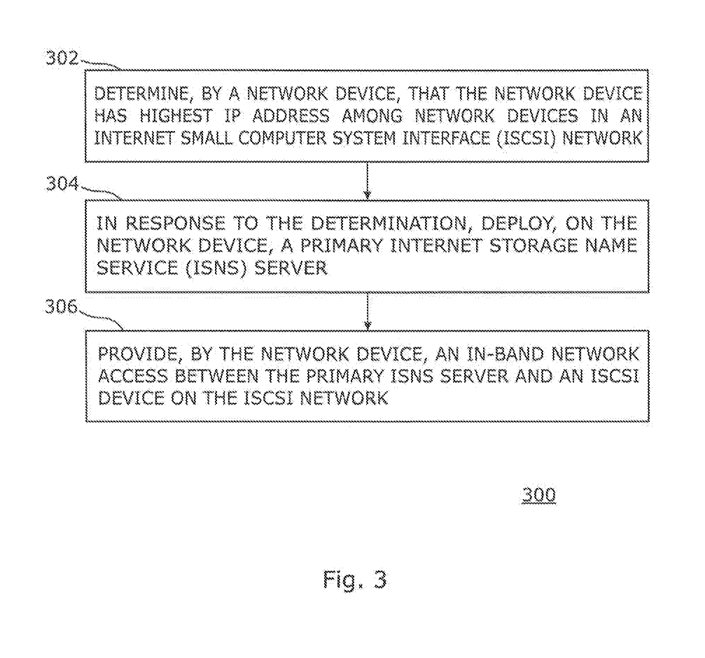

FIG. 3 is a block diagram of an example method 300 for deploying an Internet Storage Name Service (iSNS) server on a network device. The method 300, which is described below, may be partially executed on a network device such as network device 106 of FIG. 1, and network device 200 of FIG 2. However, other suitable network or computing devices may execute method 300 as well. At block 302, a determination engine (for example, 120) on a network device may determine that the network device has the highest IP address among network devices in an Internet Small Computer System Interface (iSCSI) network. At block 304, in response to the determination, a deployer engine (for example, 122) may deploy a primary Internet Storage Name Service (iSNS) server. At block 306, an access engine (for example, 124) may provide an in-band network access between the primary iSNS server and an iSCSI device on the iSCSI network.

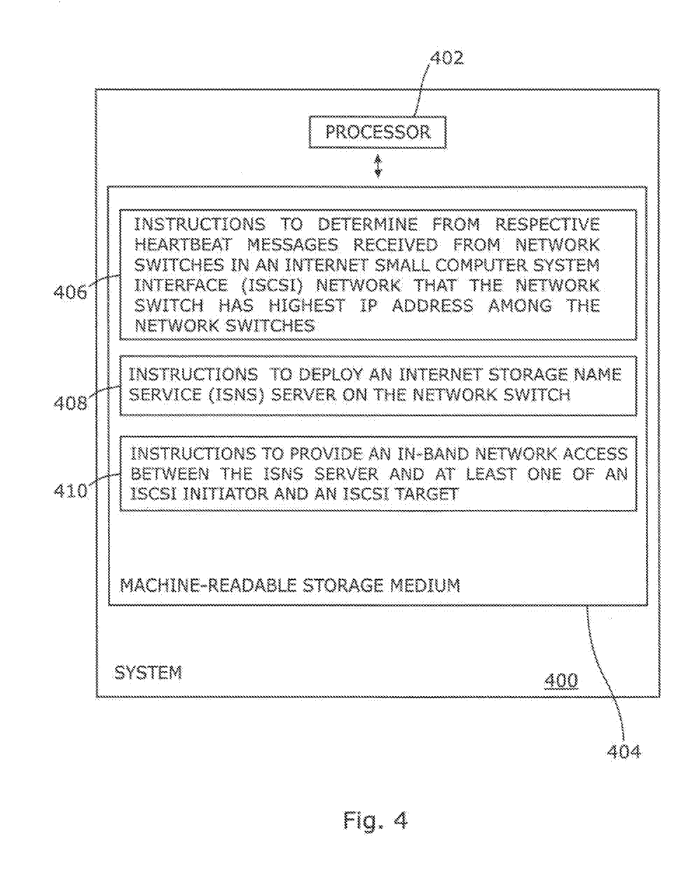

FIG. 4 is a block diagram of an example system 400 including instructions in a machine-readable storage medium to deploy an Internet Storage Name Service (iSNS) server on a network device. System 400 includes a processor 402 and a machine-readable storage medium 404 communicatively coupled through a system bus. In an example, system 400 may be analogous to network device 106 of FIG. 1, or network device 200 of FIG. 2. Processor 402 may be any type of Central Processing Unit (CPU), microprocessor, or processing logic that interprets and executes machine-readable instructions stored in machine-readable storage medium 404. Machine-readable storage medium 404 may be a random access memory (RAM) or another type of dynamic storage device that may store information and machine-readable instructions that may be executed by processor 402. For example, machine-readable storage medium 404 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In an example, machine-readable storage medium may be a non-transitory machine-readable medium.

Machine-readable storage medium 404 may store instructions 406, 408, and 410. In an example, instructions 406 may be executed by processor 402 to determine from respective heartbeat messages received from network switches in an Internet Small Computer System Interface (iSCSI) network that a network switch has a highest IP address among the network switches in the network. In response to the determination, instructions 408 may be executed by processor 402 to deploy an Internet Storage Name Service (iSNS) server on the network switch. Instructions 410 may be executed by processor 402 to provide, by the network switch, an in-band network access between the iSNS server and at least one of an iSCSI initiator and an iSCSI target.

For the purpose of simplicity of explanation, the example method of FIG. 3 is shown as executing serially, however it is to be understood and appreciated that the present and other examples are not limited by the illustrated order. The example systems of FIGS. 1, 2, and 4, and method of FIG. 3 may be implemented in the form of a computer program product including computer-executable instructions, such as program code, which may be run on any suitable computing device in conjunction with a suitable operating system (for example, Microsoft Windows, Linux, UNIX, and the like). Examples within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It should be noted that the above-described examples of the present solution is for the purpose of illustration only. Although the solution has been described in conjunction with a specific example thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

1. A method comprising:
determining, by a network device, that the network device has a highest IP address among network devices in an Internet Small Computer System Interface (iSCSI) network;
in response to the determination, deploying, on the network device, a primary Internet Storage Name Service (iSNS) server; and
providing, by the network device, an in-band network access between the primary iSNS server and an iSCSI device on the iSCSI network.

2. The method of claim 1, wherein the iSCSI device is at least one of an iSCSI initiator and an iSCSI target device.

3. The method of claim 1, further comprising:
identifying, by the network device, a second network device having second highest IP address among the network devices; and
deploying a primary backup iSNS server on the second network device in an event of failure of the network device, wherein the primary backup server acts as the primary iSNS server in the iSCSI network in response to the deployment.

4. The method of claim 3, further comprising:
identifying, by the network device, a third network device having third highest IP address among the network devices; and
deploying a secondary backup iSNS server on the third network device in an event of failure of the second network device, wherein the secondary backup server acts as the primary iSNS server in the iSCSI network in response to the deployment.

5. The method of claim 4, further comprising:
providing information related to the primary backup iSNS server and the secondary backup iSNS server to other network devices in the iSCSi network via a heartbeat message.

6. The method of claim 5, wherein the information includes at least one of IP address of the primary backup iSNS server, Transmission Control Protocol (TCP) port of the primary backup iSNS server, User Datagram Protocol (UDP) port of the primary backup iSNS server, IP address of the secondary backup iSNS server, TCP port of the secondary backup iSNS server, and UDP port of the secondary backup iSNS server.

7. A network switching device, comprising:
a determination engine to determine that the network switching device has a highest value of a counter among network devices in an Internet Small Computer System Interface (iSCSI) network;
a deployer engine to, in response to the determination, deploy on the network switching device a primary Internet Storage Name Service (iSNS) server; and
an access engine to provide an in-band network access between the primary iSNS server and an iSCSI device on the iSCSI network, wherein the in-band network access is useable by the iSCSI device to create discovery domains.

8. The network switching device of claim 7, wherein the access engine to:
receive a registration request from the iSCSI device;
in response to the request, register the iSCSI device with the primary iSNS server on the network switching device; and
store information related to the iSCSI device in an iSNS database on the network switching device.

9. The network switching device of claim 8, wherein:
the determination engine to identify a second network device in the iSCSI network; and
the access engine to synchronize the iSNS database with a second iSNS database on the second network device, wherein the second iSNS database is useable to deploy a primary backup iSNS server on the second network device in an event of failure of the network switching device.

10. The network switching device of claim 9, wherein
the determination engine to identify a third network device in the iSCSI network; and
the access engine to synchronize the iSNS database with a third iSNS database on the third network device, wherein the third iSNS database is useable to deploy a secondary backup iSNS server on the third network device in an event of failure of the second network device.

11. The network switching device of claim 10, wherein the deployer engine to, in response to a determination that the network switching device is again operational, redeploy the primary iSNS server on the network switching device.

12. A non-transitory machine-readable storage medium comprising instructions, the instructions executable by a processor of a given network switch to:
determine from respective heartbeat messages received from other network switches in an Internet Small Computer System Interface (iSCSI) network that the given network switch has a highest IP address among the network switches;
in response to the determination, deploy, on the given network switch, an Internet Storage Name Service (iSNS) server; and
provide, by the given network switch, an in-band network access between the iSNS server and at least one of an iSCSI initiator and an iSCSI target.

13. The storage medium of claim 11, wherein the in-band network access is useable by the iSCSI target to create discovery domains.

14. The storage medium of claim 11, wherein the instructions to deploy include instructions for a daemon process to deploy the iSNS server on the network switch.

15. The storage medium of claim 11, wherein the in-band network access is useable by at least one of the iSCSI initiator and the iSCSI target to register with the iSNS server.
